(19) United States
(12) Patent Application Publication
(10) Pub. No.: US 2017/0021436 A1
(43) Pub. Date: Jan. 26, 2017

(54) BLIND CUTTING DEVICE FOR CUSTOM SIZING OF WINDOW BLINDS

(71) Applicants: Brian Donahue, New Richmond, WI (US); Vance Rades, Andover, MN (US)

(72) Inventors: Brian Donahue, New Richmond, WI (US); Vance Rades, Andover, MN (US)

(21) Appl. No.: 15/042,691

(22) Filed: Feb. 12, 2016

Related U.S. Application Data
(60) Provisional application No. 62/115,850, filed on Feb. 13, 2015.

(51) Int. Cl. B23D 45/00; E06B 9/266; B23D 47/04; B26D 7/22; B23D 45/02; B23D 59/00

(52) U.S. Cl. CPC B23D 45/003; B23D 45/022; B23D 59/006; B23D 47/04; B26D 7/22; E06B 9/266

(57) ABSTRACT

The safe and efficient cutting of window blinds can be accomplished by utilizing a blind cutting system which is configured to support and contain the blinds in a desired position, and to have a cutting saw move along a cutting plane such that a cutting blade will interact with the blinds and cut a predetermined portion from an end thereof. A framework is used to support the cutting saw and allow movement of a cutting blade in a very controlled manner, thus avoiding any possibility that the blade is positioned in a dangerous position during operation. Further, the travel of the cutting blade along a cutting path will create a cutting action in a controlled and defined manner. Further, the cutting blade is shielded on virtually all sides, thus eliminating the possibility of injury or harm to a user.

### BACKGROUND

Window coverings take on many different styles and are an integral part of interior design. One commonly used type of window covering is the slated blind, which hangs in front of a window and can be easily opened or closed by adjusting the angles of the slats. Other styles or types of blinds are also well known, such as cloth blinds, accordion style, faux blinds, woven, nonwoven, mini, cellouse, etc. As can be expected however, having window blinds that fit the size of the window is important from both a functional and aesthetic perspective. Ideally, the slats, head rail, bottom rail, valence, chambers, and any other materials making up the blinds are cut to match the size of the window opening to achieve the desired customized fit.

As can be anticipated, it is inefficient and impractical to manufacture blinds of every conceivable size. Thus, manufacturers typically offer sets of “standard” size blinds, and provide the ability to customize by trimming the edges of the slats, and/or removing slats from the set. This customization may be done at a retail store, a wholesale location, or on-site when the blinds are installed. Wherever the process may be carried out, it is desirable to perform this cutting in a controlled and efficient manner to insure the cuts are consistent and clean, since the blind edges are typically visible when installed.

Systems exist for cutting slats, but tend to be either sizable and complex, or very manual and dangerous. In addition, a considerable amount of human interaction is often required to set-up the machines to properly cut to specific dimensions. Since human interaction is required, this creates an opportunity for error and inconsistency.

### BRIEF DESCRIPTION OF THE DRAWINGS

The features and benefits of the various embodiments will be better understood by reading the following description of the various embodiments, in conjunction with the drawings, in which:

FIG. 1 is a perspective view of the cutting system;

FIG. 2 is a second perspective view from a different angle;

FIG. 3 is a front view thereof;

FIG. 4 is a rear perspective view;

FIG. 5 is a side view thereof; and

FIG. 6 is a close up view of certain elements of the framework and holding mechanisms.

### DESCRIPTION OF THE VARIOUS EMBODIMENTS

To allow for the straight forward and efficient cutting of window blinds, a cutting system is further described below which provides users with the ability to easily determine the desired dimensions, and to quickly and efficiently set up the cutting device to consistently cut for these dimensions. This approach provides the ability to safely and efficiently cut blinds to custom dimensions, as desired. As will be further outlined, the cutting saw is carried by a supporting device, which is slideable along a predetermined path. The structure is configured so that the cutting blade of the saw is positioned away from a user, and predominately shielded. In this manner the blade is mostly inaccessible and consequently the system provides additional levels of safety. Further, a supporting and holding mechanism is provided which allows a user to easily position the window blinds, and quickly and efficiently set up the system for cutting of blinds to a desired custom dimension.

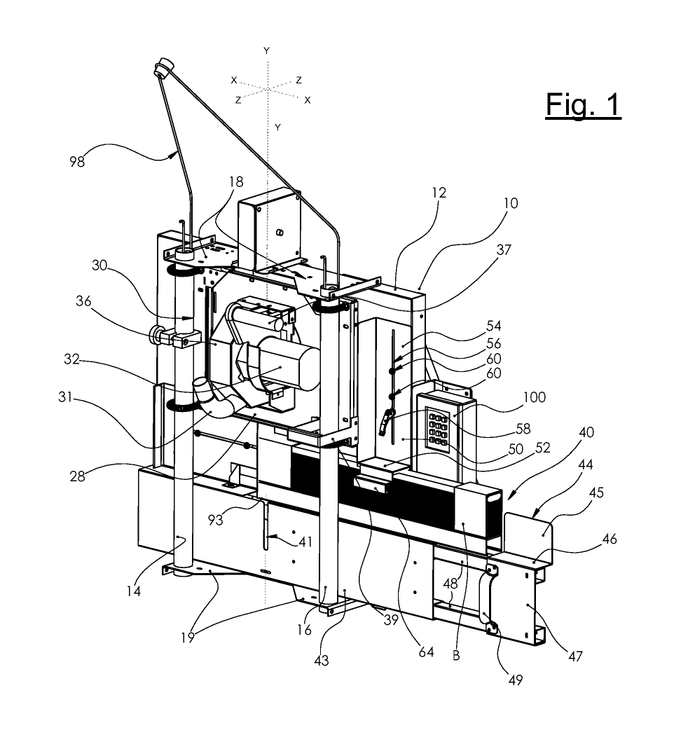

Turning now to FIG. 1, a first perspective view of the blind cutting device 10 is further illustrated. Generally speaking, blind cutting device 10 includes a framework structure 12 which provides general support for the remaining components. In this embodiment, framework structure 12 is a primarily planar structure which is supported on a surface(s) (e.g. floor or tabletop), and held in an operating position by a retractable support leg 15. In this case, the operating position is approximately 10 degrees from upright (or approximately 80 degrees with respect to the supporting surface. While framework 12 supports many different components, several of these include a first rail 14 and a second rail 16, which are welded to a top bracket 18 and a bottom bracket 19. Both top bracket 18 and bottom bracket 19 are attached to framework 12 at an upper location and a lower location, respectively. First rail 14 and second rail 16 are configured to be substantially parallel with one another, positioned in a substantially upright orientation, and help to define the path along which a cutting saw or cutting device 30 travels.

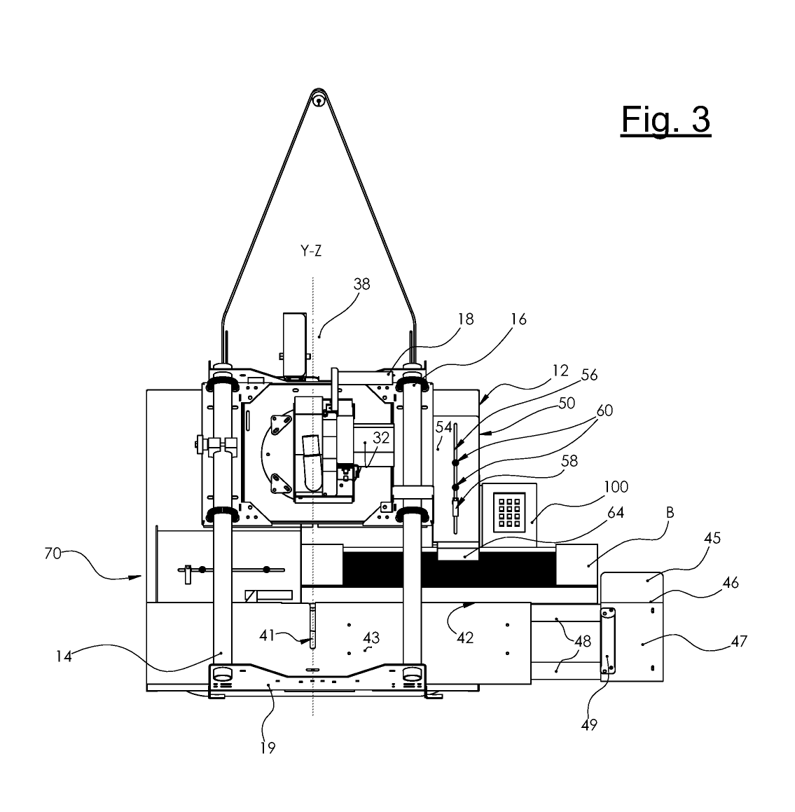

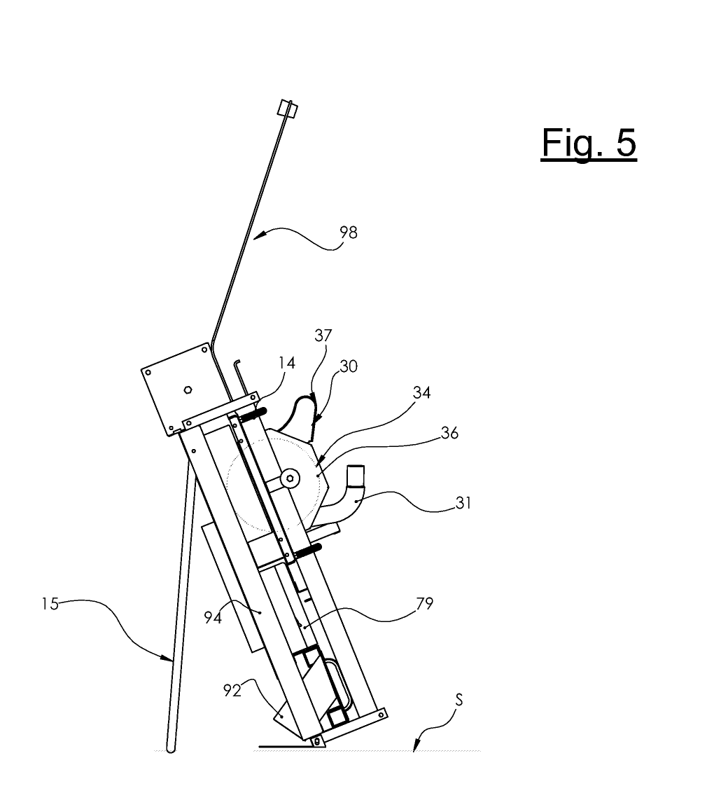

In the illustrated example, a cutting saw 30 is utilized to cut blind (B), with the cutting saw 30 generally including a motor 32, a cutting blade 34 (not shown in FIG. 1), a backside shielding system 36, and operating handles 37 and 39. The shielding system 36 is designed and configured to conceal cutting blade 34 during operation, and to provide an additional level of safety to the system (cutting blade 34 is illustrated in dashed lines in FIG. 5 to provide an example of anticipated positioning). Cutting saw 30 is generally carried on a carriage mechanism 28. As will be appreciated by those skilled in the art, carriage 28 is designed and configured to ride on first rail 14 and second rail 16, and thus travel in a linear motion, with the cutting blade 34 staying primarily within a cutting plane 38 (shown as an axis 38 in FIGS. 3 & 6, since cutting plane 38 will be perpendicular to the page, and also situated along a Y-Z plane as shown in FIGS. 1 & 2). Stated differently, cutting blade 34 will travel within one defined cutting plane 38 as carriage 28 is moved upwardly and downwardly along parallel rails 14 and 16. A front panel 43, which cooperates with a portion of a material or blind supporting structure 40, includes a cutout 41 (best shown in FIGS. 1-3 & 6) which accommodates a lower portion of the area where cutting blade 34 will travel.

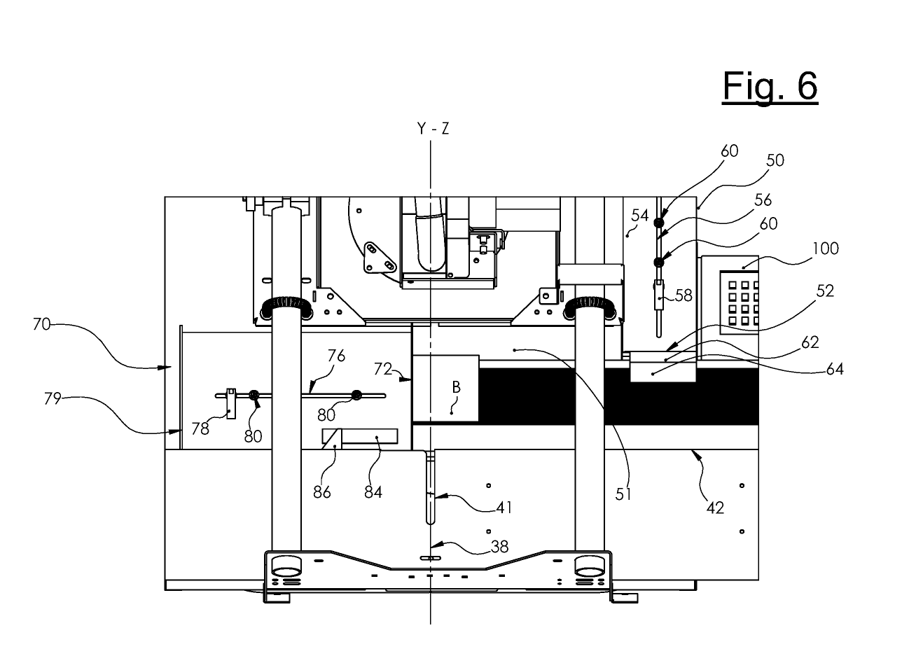

As best illustrated in FIGS. 1 & 2, attached to framework 12 is a material or blind supporting structure 40. This structure is specifically configured to support a package of window blinds, before and during cutting operation. Supporting structure 40 includes a two part supporting surface having a generally fixed horizontal support surface 42 and a slidable horizontal support surface 46 upon which the blind packages may be rested or placed prior to cutting operations. As can be seen, blind supporting structure 40 is adjustable, using an integrated sliding structure 44. While various approached can be used to achieve this adjustability, the current embodiment makes use of a pair of rods or posts 48 and a handle 49 at an end portion of the blind supporting structure 40. Moving this adjustable or sliding portion 44 outward will effectively create an extension of supporting surface 42 and front panel 43 (i.e. with surface 42 and support surface 46 being situated in generally in the same plane, and with front panel 43 and panel 47 being situated in the same plane). Although these surfaces are referred to as generally “horizontal”, the preferred embodiment maintains a predetermined angle or tilt (as mentioned above) to help retain or hold the blinds (B) during cutting, thus these surfaces are not strictly “horizontal”. As mentioned above, supporting structure 40 is adjustable to accommodate the cutting of blinds having different sizes. As illustrated, supporting surfaces 42 and 46 are configured to be perpendicular to cutting plane 38. In addition, a generally upright surface formed by surfaces or panels 51 and 45, which is perpendicular to supporting surfaces 42 and 46, and also perpendicular to cutting plane 38, helps to support blinds (B) during cutting. (Note that panel 51 is not visible in FIGS. 1-3 since it is behind the blinds (B), but can be partially seen in FIG. 6). As further discussed below, blind packages are supported on supporting surfaces 42 and 46, and moved into a desired position relative to the cutting plane 38. The above mentioned adjustable portion 44 allows a considerable portion of the blinds (B) to held or supported on the supporting surfaces 42 and 46. Alternatively, these mechanisms can be adjusted to support the entire length of the blind (B).

Once blinds (B) are in the desired position, saw 30 is moved along with carriage 28 causing cutting blade 34 to travel along cutting plane 38, and cut off a desired portion of the blinds. As illustrated, supporting surfaces 42 and 46 extend perpendicularly away from cutting plane 38, and thus are capable of accommodating blinds of many different lengths. In addition, the orientation of supporting surfaces 42 and 46 causes the blinds to be positioned with a head rail of the blind positioned on supporting surfaces 42 and 46, and the slats/bottom rail directly above, thus making cutting operations both consistent and efficient. Alternatively, the bottom rail of the blind may be positioned on the supporting surfaces 42 and 46, with the head rail and slats immediately above (i.e. in substantially the same orientation as they will be installed and used.) Again, by positioning in this manner and cutting with a substantially vertical motion, the consistency and efficiency of the cut is maximized. It is contemplated that the blinds may stay within their packaging while being cut, thus holding the slats in a close relationship to one another. In practice, it is likely that outer wrapping will be removed, but holding straps or bands will remain in place so the overall blind structure (and the multiple slats typically included in the blinds) is “contained”. In this manner, the cutting operation of the blinds (B) is both efficient and quickly carried out.

Cooperating with supporting shelf 40 is a slideable holding clamp 50, which is also movably attached to framework 12. Slideable holding clamp 50 includes a clamping surface 52 and a slide plate 54 which are oriented at approximately right angles to one another. Slide plate 54 includes a groove 56 which is configured and specifically designed to interact with a pair of shoulder bolts 60 which are attached to framework 12. Shoulder bolts 60 maintain the positioning of slide plate 54 as slideable holding clamp 50 is operated. A locking mechanism 58 is also attached. It will be recognized by those skilled in the art that this locking mechanism 58 is a lever/cam type mechanism, which provides clamping/holding features. As will also be appreciated, in use slideable holding clamp 50 is moved into contact with the blind material, the activation of locking mechanism 58 will essentially clamp or hold the blind material in the desired position. To further accommodate the movement of slidable holding clamp 50, a handle structure 64 is formed at a lower end, extending from an edge of clamping surface 52. In this way, a user can appropriately position clamping surface 52, by grabbing handle structure 64 and sliding into position.

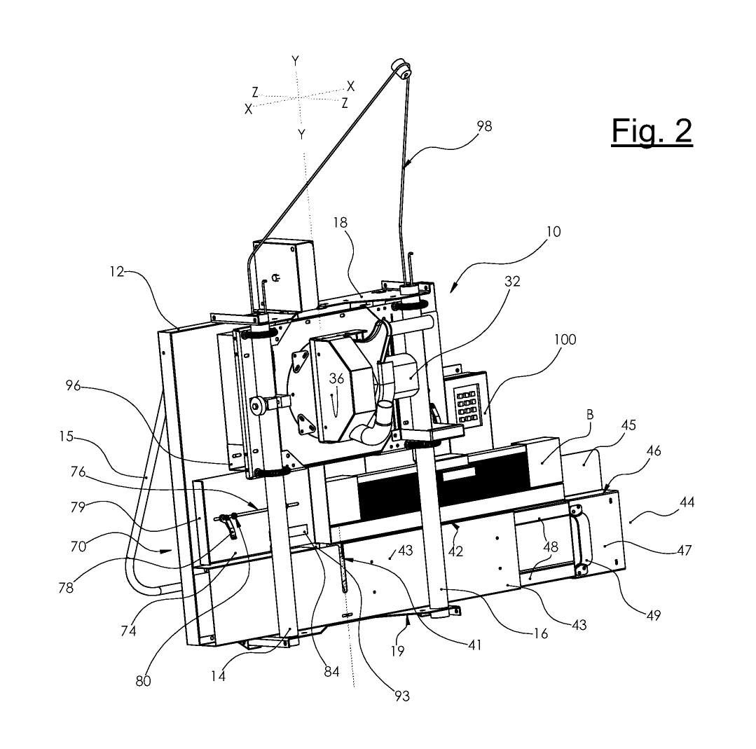

As better illustrated in FIGS. 2 & 6, cutting device 10 further includes a slideable registration stop mechanism 70 which is positioned adjacent supporting surface 42. As illustrated in FIG. 3, slideable registration stop mechanism 70 includes a stop surface 72, which helps to provide repeatable positioning of the blinds during cutting operations. Stop surface 72 is also an integral portion of the measurement system, which accommodates the consistent and repeatable measurement capabilities of blind cutting device 10. More specifically, slideable registration stop mechanism 70 includes a slide plate 74 which is substantially perpendicular with stop surface 72 (with stop surface also being substantially parallel with cutting plane 38). Slide plate 74 has a groove 76, similar to the groove 56 discussed above in relation to slideable holding clamp 50. Again, a pair of shoulder bolts 80 are attached to framework 12 and specifically configured to be received within groove 76. A locking mechanism 78 is also coupled with slideable plate 74, to lock the slideable registration stop 70 in a desired position. A handle 79 is also an integral part of slideable registration stop 70, thus allowing for easily positioning this component. The dimensions of groove 76 and the positioning of shoulder bolts 80 are specifically configured so that stop surface 72 does not intersect with cutting plane 38. Naturally, it is acceptable to have the stop surface 72 be positionable in very close proximity to cutting plane 38, thus allowing for very fine adjustments to the blinds. In this way, it would not be possible for cutting blade 34 to contact this portion of slidable registration stop mechanism 70, thus avoiding a possible dangerous situation.

In addition to the components mentioned above, a ruler 84 is attached to the surface of slide plate 74. As better illustrated in FIG. 6, slide plate 74 and ruler 84 move together. Cooperating with ruler 84 is an indicator tab 86 which is rigidly affixed to framework 12, support shelf 40, or some other fixed component of blind cutting device 10. As will be appreciated, as slide plate 74 is moved, ruler 84 is moved a similar distance, while indicator tab 86 remains fixed. In this manner, it is easy for a user to determine exactly how far stop surface 72 has been moved. By appropriately calibrating these two components, a user can easily set a desired cut off distance. In use the blinds will then be positioned against the stop surface 72, ensuring that a desired distance exists between the end of the blinds and the cutting plane. As will be appreciated, the positioning of stop surface 72 relative to cutting plane 38 provides a fixed repeatable measurement technique. As will also be appreciated, it may be beneficial and equally effective to have the ruler 84 rigidly affixed to framework 12, and incorporate a similar indicator tab 86 as part of slide plate 74.

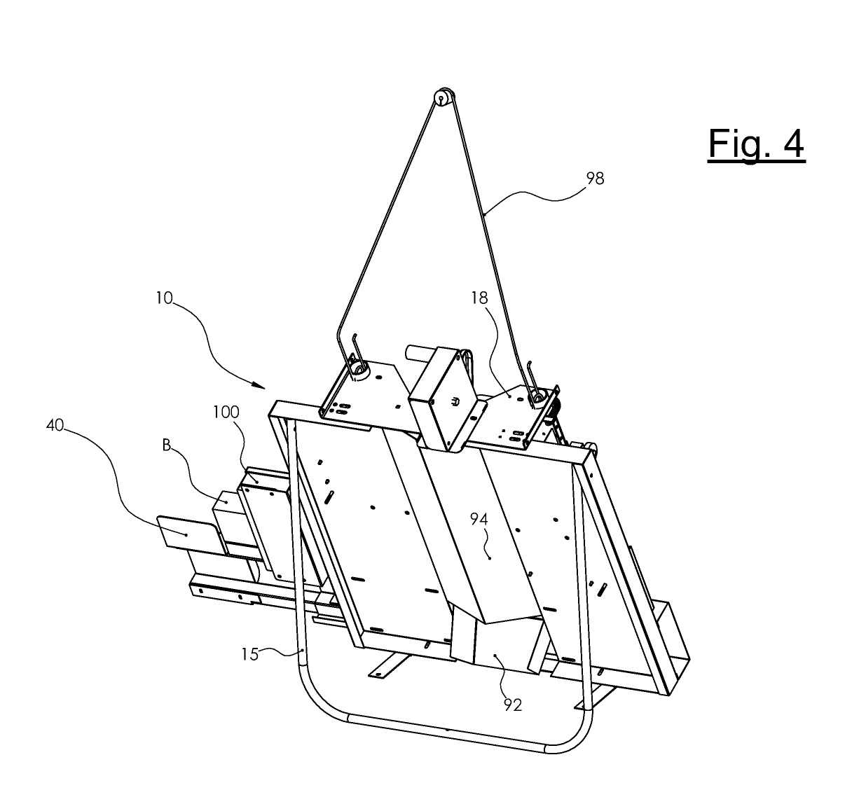

In addition to the mechanisms described above, which are primarily directed towards the safe and repeatable cutting operations, the present blind cutting device 10 also includes an efficient waste handling system. More specifically, a waste handling chute 92 is positioned at a bottom portion of blind cutting device 10. As best shown in FIGS. 4 & 5, waste handling chute 92 is positioned at an angle and directly below the cutting area. As also illustrated in FIG. 5, framework 12 is supported by leg 15 to maintain an angular position with respect to the supporting surface (S) upon which cutting device 10 is placed or located. By maintaining this angled position, and by appropriately positioning the various components, any scrap which has been cut from the blinds will drop into chute 92 and be directed towards a containment area. In the preferred embodiment, the containment area will accommodate the position and placement of a standard garbage can (not shown). That said, it is easily understood that several different types of waste handling containers could be utilized. Cooperating with waste handling chute 92 is an opening 93, which is best shown in FIGS. 1 & 2. Opening 93 is position to allow waste material, cut from blinds B, to drop there through, and fall into contact with chute 92. In addition, the system includes a dust outlet 31 configured to be used along with a vacuum system or related dust handling system (not shown). In this manner, waste is quickly and efficiently removed during the cutting process.

Lastly, all of the various FIGS roughly reference a cord handling mechanism 98, which is designed to keep cords away from the user and the saw. Naturally, several alternatives exist for this feature. In addition, the system 10 includes additional features to provide safety. A control module 100 is included which requires a user to enter a code on a keypad before operation will start. In addition, cutting saw 30 has handles 37 and 39 for placement of the users hands away from cutting blade 34. Further, shielding is provided to substantially surround the cutting blade during operation. As again best illustrated in FIG. 4, a rear shield 94 (which is an integral part of framework 12 in this embodiment) covers a rear portion of the device 10 where the blade is allowed to travel. In addition, a top shield system 96 is included above and surrounding the cutting area. In practice, top shield system 96 may include multiple portions specifically designed to interact with the cutting system 10. Top shield 96 will specifically prevent a user from inserting their hands into cutting blade 34, when carriage 28 is in an upper position, by surrounding the right and left sides of cutting blade 34. Additionally, as shown in FIG. 1, a side portion of slidable holding clamp 50 will also provide shielding. In this manner, the blade 34 is shielded or protected from virtually all sides.

While various details are generally described above, it is contemplated that cutting system 10 of this embodiment is designed to cut blinds B having a depth of up to 2.0 inches, and will use a cutting blade 34 of approximately 8.25 inches. In addition, slidable holding clamp 50 is sized to accommodate a blind B having heights of 3.75 to 8.25 inches (i.e. the height of the stacked blinds when placed on supporting surface 42). Further, slidable registration stop 70, is configured to allow cutting of 0.25 to 2.5 inches from the end of the blinds B. That said, several alternatives and variations are possible.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A blind cutting system for customizing window blinds, comprising:
A framework;
a pair of substantially parallel rails attached to the framework and oriented in a near vertical position during operation of the blind cutting device;
a cutting saw slidably coupled to the pair of rails, the cutting saw having a cutting blade which is movable along a cutting path, which is contained within a portion of a cutting plane, when the saw is moved along the pair of rails, wherein the cutting plane is also substantially parallel to the pair of rails;
a holding structure coupled to the frame and positioned in predetermined position relative to the pair of rails, the holding structure comprising an adjustable support shelf, a slidable holding clamp, and a slidable registration stop, wherein the adjustable support shelf is capable of being sized to support the blinds to be cut and has supporting surface which is and normal to the cutting plane, wherein the slidable holding clamp has a clamp surface substantially parallel to the supporting surface which is movable in a direction normal to the clamp surface and the supporting surface, and wherein the slidable registration stop has a stop surface oriented substantially parallel with the cutting plane and movable in a direction normal to the cutting plane and the stop surface; and
a waste handling chute positioned at least partially in the cutting plane but below the cutting path, the waste handling chute directing cut-off waste material to a predetermined location adjacent the framework.

2. The blind cutting system of claim 1 wherein the slidable holding clamp and the slidable registration stop both have locking mechanisms to lock the stop surface and the clamp surface in predetermined position.

3. The blind cutting system of claim 2 wherein the slidable holding clamp comprises a slide plate having a groove formed therein, wherein the groove is oriented in alignment with the direction of travel, and wherein the framework comprises at least one shoulder bolt which extends through the groove to control the travel of the holding clamp.

4. The blind cutting system of claim 2 wherein the slidable registration stop comprises a slide plate having a groove formed therein, wherein the groove is oriented in alignment with the direction of travel, and wherein the framework comprises at least one shoulder bolt which extends through the groove to control the travel of the registration stop.

5. The blind cutting system of claim 4 wherein the travel of the registration stop is specifically limited to insure that the registration stop does not intersect with the cutting path.

6. The blind cutting system of claim 1 wherein the cutting saw further has a plurality of blade shields such that the blade is substantially shielded from a user during cutting operations.

7. The blind cutting system of claim 1 wherein the waste chute is positioned such that waste material can fall directly downward when cut and be captured by the waste chute.

8. The blind cutting system of claim 1 further comprising a rear shield attached to and positioned on a back side of the framework, the rear shield having a recessed portion therein to shield an exposure of the cutting blade from a rear side as the cutting blade moves along the cutting path.

9. The blind cutting system of claim 1 wherein the registration stop has a location indicator thereon which is positionable adjacent a scale, wherein the indicator and the scale are indicative of the amount of the blind to be cut.

10. The blind cutting system of claim 1 wherein the cutting saw is mounted to a carriage, and the carriage is slidably coupled to the rails, such that the entire carriage is movable.

11. A blind cutting system for safely and cutting window blinds to precise dimensions, comprising:
an adjustable support structure having a support shelf to support the blinds to be cut, a slidable holding clamp movable to a holding position above the blinds to be cut, and a slideable registration stop, wherein the registration stop has a stop surface substantially perpendicular to the support shelf;
a cutting saw having a circular cutting blade arranged in a cutting plane and movable along a cutting path, wherein the cutting path is substantially parallel with the stop surface and intersects a plane formed by the support shelf, the cutting saw having a plurality of shields configured to shield the cutting blade around greater than 180 degrees thereof;
a waste chute positioned below the support shelf, and in line with the cutting path, such that any material cut from the blind will fall into the waste chute; and
a rear shield positioned behind the support structure and along the cutting path, the rear shield having an opening configured to accommodate and shield the cutting blade as it moves along the cutting path.

12. The blind cutting system of claim 11 further comprising a framework to support the adjustable support structure and to accommodate a saw carriage system which allows the cutting saw to travel along the cutting path, wherein the carriage system includes a plurality of rails and a carriage movably coupled thereto thus allowing the carriage to travel along the rails, the cutting saw coupled to the carriage such that the carriage and the rails control the positioning of the cutting path.

13. The blind cutting system of claim 12 wherein the rails are supported in a near vertical orientation and the cutting path is in a substantially vertical plane, and wherein the support surface is configured such that the downward movement of the cutting blade will cause the cutting blade to interact with a blind placed on the support surface.

14. The blind cutting system of claim 13 wherein the registration stop has a scale thereon which is positionable adjacent an indicator which is attached to the support structure, wherein the indicator and the scale are indicative of the amount of the blind to be cut.

15. The blind cutting system of claim 13 wherein the registration stop has a location indicator thereon which is positionable adjacent a scale attached to the support structure, wherein the indicator and the scale are indicative of the amount of the blind to be cut.
